(19) United States
(12) Patent Application Publication
(10) Pub. No.: US 2015/0186253 A1
(43) Pub. Date: Jul. 2, 2015

(54) STREAMLINED PERFORMANCE TESTING FOR DEVELOPERS

(71) Applicant: Microsoft Corporation, Redmond, WA (US)

(72) Inventors: Arun M. Abraham, Redmond, WA (US); Raul Gonzalez Tovar, Redmond, WA (US); Jonathan A. Boles, Seattle, WA (US); Eamon G. Millman, Bellevue, WA (US)

(21) Appl. No.: 14/144,131

(22) Filed: Dec. 30, 2013

(51) Int. Cl. G06F 11/36

(52) U.S. Cl. CPC G06F 11/3688; G06F 11/3684

(57) ABSTRACT

Performance testing is streamlined to facilitate assessing software performance. A performance test can be authored similar to familiar functional tests but with a tag that indicates the test is a performance test and specifies a data collection mechanism. Performance data collected during test execution can subsequently be reported to a software developer in various ways. Performance testing can also be integrated with one or more of a team development system or an individual development system.

### BACKGROUND

Performance testing is a practice that strives to determine whether software applications perform as expected in terms of responsiveness, throughput, and resource usage, among other factors. By contrast, regular functional testing is a different type of testing that seeks to determine whether an application functions as expected in terms of output produced in response to some input. Performance testing can be employed to verify that software meets specifications claimed by a vendor, identify sources of performance problems (e.g., bottlenecks), and support performance tuning, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to streamlining performance testing for developers. A performance test can be authored similar to a familiar functional test, except with a tag that identifies the test as a performance test and specifies a data collection mechanism. Support is provided to enable collection and storage of performance data acquired during test execution. Various reports can be generated and provided to developers pertaining to performance data and optionally supplemented with other performance related information. Furthermore, performance testing can be integrated within one or more of a team development system or an individual development system.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a performance testing system.

FIG. 2 is a block diagram of a team development system.

FIG. 3 is a block diagram of an individual development system.

FIG. 4 is a flow chart diagram of a method of performance testing.

FIG. 5 is a flow chart diagram of a build method.

FIG. 6 is a flow chart diagram of a check-in method.

FIG. 7 is a flow chart diagram of a performance testing method.

FIG. 8 is a flow chart diagram of a method of performance testing.

FIG. 9 is a flow chart diagram of a performance testing method.

FIG. 10 is a schematic block diagram illustrating a suitable operating environment for aspects of the subject disclosure.

### DETAILED DESCRIPTION

Performance testing is conventionally difficult to perform. One reason is performance testing is highly domain specific in terms of techniques employed to perform testing. More particularly, performance testing usually requires custom tools, libraries, and frameworks suited for specific software to be tested. Accordingly, those that desire performance testing typically generate custom performance testing systems substantially from scratch. Further, dedicated performance labs are typically setup to provide a consistent test environment, and dedicated performance teams, skilled in implementing performance tests, are assembled. There can also be many manual setup and deployment tasks adding to the difficulty.

Details below generally pertain to streamlining performance testing for developers of software. In furtherance thereof, authoring of performance tests is simplified. Rather than being specialized, performance tests can resemble familiar functional tests, except with a tag that indicates the test is a performance test and specifies data to be collected. Further, support can be provided to enable collection and storage of performance data acquired during test execution. The performance data can subsequently be reported to a developer in a variety of ways and optionally supplemented with other performance related information. Furthermore, performance testing can be integrated with various software development technologies such as a team development system and an individual development system. Consequently, performance testing can be carried out during a normal software development process.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

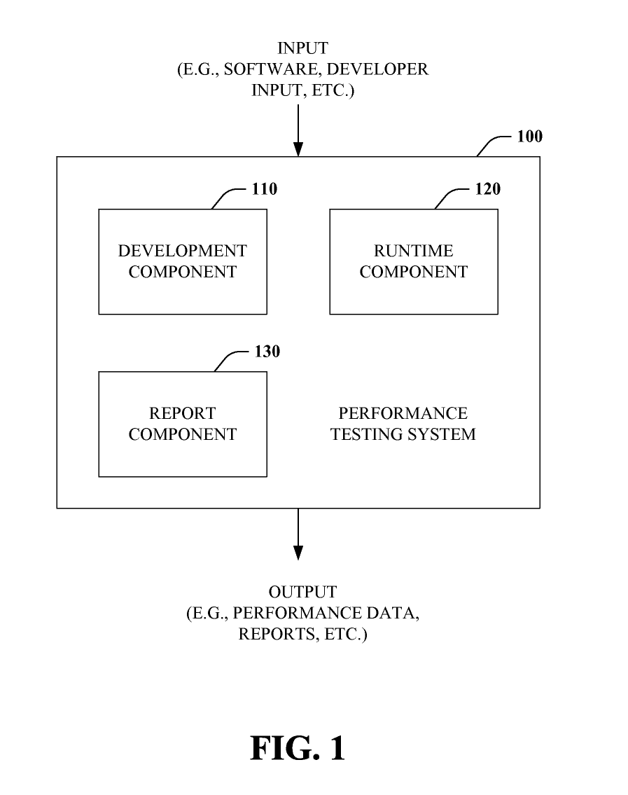

Referring initially to FIG. 1, performance testing system 100 is illustrated. The performance testing system 100 is configured to integrate or tightly couple several features to allow software performance to be easily assessed based on execution of performance tests over software subject to test. In particular, the performance software system includes development component 110, runtime component 120, and report component 130.

The development component 110 is configured to facilitate authoring performance tests. More particularly, the development component 110 can provide a set of one or more software development tools that enables creation of performance tests. For example, the tools can correspond to one or more applications programming interfaces, libraries, debugging aids, and/or other utilities. In one embodiment, the development component 110 can be implemented as a software development kit.

A performance test created in conjunction with the development component 110 can resemble a familiar functional test, except that the test is tagged to indicate it is a performance test. In accordance with one embodiment, such metadata can be encoded as an attribute. For example, the attribute “PerformanceTestAttribute” can indicate that a test is a performance test. Of course, any other manner of identifying at least a segment of code (e.g., computer program instructions) as a performance test can be employed. Further, an abstract attribute can be utilized to allow specification and use of different mechanisms for performing data collection. For example, Event Tracing for Windows (ETW), Code Markers, or any other instrumentation can be employed for collecting data. In other words, a tag, or like mechanism, can not only identify code as a performance test but also identify a particular data collection mechanism to employ, among other things.

To facilitate clarity and understanding, consider the following exemplary performance test:

```
[TestMethod]
[EtwPerformanceTest(“TestMethod1_MeasurementBlock”)]
public void TestMethod1( )
{
    Product product = new Product( );
    using (MeasurementBlock.BeginNew(1,
    “TestMethod1_MeasurementBlock”))
    {
        product.DoSomething( );
    }
}
```

Here, the attribute “EtwPerformanceTest” indicates that the code that follows is a performance test that uses ETW for data collection. Further, the property “TestMethod1_MeasurementBlock” indicates that for this test, central processing unit time is collected between the start and end events of the measurement block named “TextMethod1_MeasurementBlock.” In the test body, this measurement block is fired, wrapped around the “DoSomething” method on a type “Product,” which means it measures the time to execute the method. Of course, this measurement block could have been inserted into the product code as well, which is actually more common. For instance, consider the following exemplary snippet:

```
[TestMethod]
[EtwPerformanceTest(“DoSomethingCriticalBlock_MeasurementBlock”)]
public void TestMethod1( )
{
    Product product = new Product( );
    product.DoSomething( );
}
public class Product
{
    public void DoSomething( )
    {
        using (MeasurementBlock.BeginNew(1,
“DoSomethingCriticalBlock_MeasurementBlock”))
          {
              // Performance code here
          }
    }
}
```

These simple exemplary tests illustrate use of tags with respect to test methods solely to facilitate clarity and understanding. A typical scenario, however, might be more complex, for example by measuring part of what a method does or measuring the time to execute multiple actions.

As disclosed above, authoring of a test is relatively simple process. In addition to writing tests from scratch, previously written tests can be edited to function as performance tests in substantially the same way. More specifically, a tag can be added to the test, which indicates that the test is a performance test and specifies a data collection mechanism. For example, previously written functional tests can be converted into performance tests.

Furthermore, the development component enables development of tests for scenarios at all levels of granularity, including for unit tests. Conventionally, performance tests are long running tests that catch a variety of things. However, when there is a performance issue it is difficult to determine where the problem is within a long running test. Here, performance can be checked at a finer level of granularity, such as at the unit level, therefore making it easier to determine a cause of a performance problem. Moreover, by making it simple to author tests, developers can be motived by the low time cost to produce performance tests directed toward more fine-grained scenarios than they would produce otherwise.

By way of example, consider the following sample code snippet:

```
[TestMethod]
[EtwPerformanceTest(“DoSomething_1000_Times”)]
public void TestMethod1( )
{
    Product product = new Product( );
      using (MeasurementBlock.BeginNew(1,
      “DoSomething_1000_Times”))
      {
            for (int count = 0; count < 1000; count++)
            {
                product.DoSomething( );
            }
        }
    }
}
public class Product
{
      public void DoSomething( )
      {
            // Performance code here
      }
}
```

Here, a developer measures the performance times of a fast but critical block of code one thousand times. This is how units of code can be realistically measured.

The runtime component 120 is configured enable execution of performance tests authored as described above with respect to the development component 110. More specifically, the runtime component 120 can support and enable collection and storage of performance data for a particular test case. For example, the runtime component 120 can understand a tag and knows how to collect data based on the tag. Further, the runtime component 120 is extensible enabling addition of custom data collection mechanisms, if desired. Furthermore, existing collection mechanisms can be extended to support additional functionality. By way of example, and not limitation, a collection mechanism can be extended to invoke a performance profile upon detection of performance regression. Still further yet, note that collection mechanisms can track a variety of performance aspects such, but not limit to, time, memory, input/output, power/battery consumption, and external resources.

The report component 130 is configured make at least performance data available to developers. The report component 130 is operable to access raw data acquired by one or more collection mechanisms and presents data in an easily comprehensible form utilizing text, graphics, audio, and/or video, for example. In one particular instance, the report component 130 can produce a report, for example, that indicates how long something took to run or an average time over multiple runs. A generated report can also be interactive so that developers can identify particular data of interest and filter out data that is not of interest, among other things. Further, the report component 130 can be configured to automatically detect instances of unacceptable performance and notify a designated person or entity. For example, the report component 130 can automatically determine performance regressions across runs and notify a developer. Additionally or alternatively, the report component 130 can be provided and work with criteria that identify acceptable performance and when notification should be provided. For example, a developer can specify notification upon detection of regression exceeding ten percent. Further, the report component 130 can be configured to supplement performance data with additional data from profile reports or trace files, or other sources that relate to how software performs.

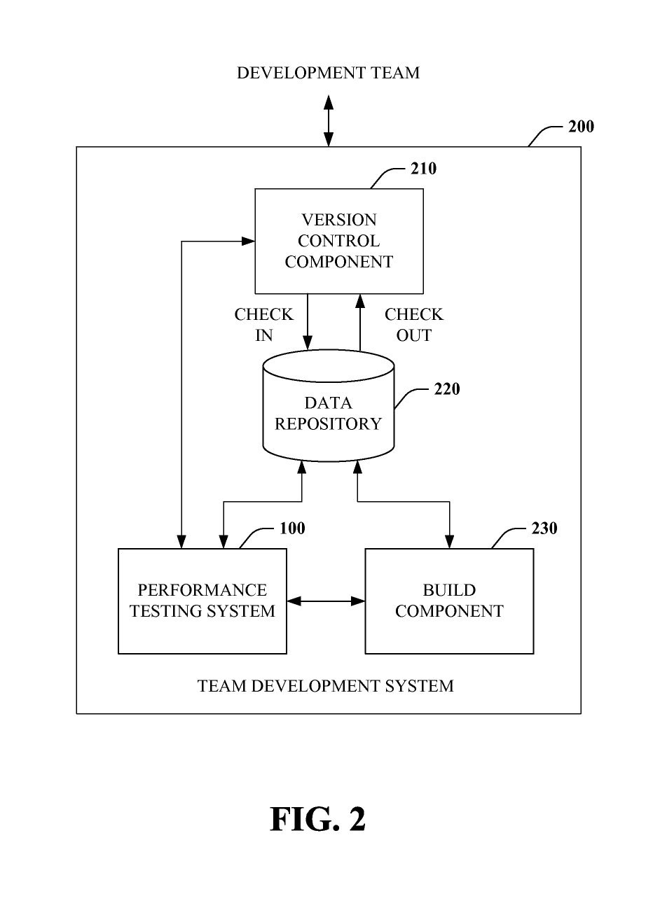

FIG. 2 depicts team development system 200, which integrates the performance testing system 100. The team development system 200 is configured to enable team (e.g. multiple developers) collaboration on software development projects. The team development system 200 includes version control component 210, data repository 220, build component 230, and the performance testing system 100.

The version control component 210 is configured to manage data including source code, among other things. When teams develop software, it is common for multiple version of the same software to be worked on simultaneously by multiple developers. The version control component 210 enables changes to a set of data to be managed over time. As part of such management, source code can be checked out from the data repository 220 (a.k.a., team development repository), which is a persistent, non-volatile, computer-readable storage medium. Stated differently, the latest version of source code is retrieved from the data repository 220. When a developer checks out code, the developer obtains a working copy of the code. After changes are made to the code, a developer is said to check in the code. In other words, the code including edits is submitted back to the data repository 220. Upon receipt, the version control component 210 can merge the changes and update the version.

The build component 230 is configured manage production of computer executable code from source code, among other things. For instance, the build component 230 can employ compilers and linkers to compile and link files in particular order. The result of the build component 230 can simply be referred to as a build. Further, all or a portion of a build process performed by the build component 230 may need to be executed upon changes to source code. For example, a file may need to be recompiled. The build component 230 is coupled to the data repository 220 that, among other things, stores source code for a particular software project. After changes are made and checked in, the build component 230 can produce corresponding executable code. In one instance, the build component 230 can be triggered explicitly by way of a build request. Alternatively, a build process can be initiated automatically sometime after changes are made. For example, the build process can be initiated automatically upon code check-in or change detection. Alternatively, the build process can be initiated periodically (e.g., daily, weekly . . . ).

In accordance with one embodiment, build component 230 can initiate performance testing by way of the performance testing system 100. For example, after completing a build process, the build component 230 can initiate performance testing. In one implementation, the build component can simply instruct the performance testing system to execute the tests. Alternatively, the build component 230 can locate performance tests stored in the data repository 220, and employ a runtime afforded by the performance testing system to execute the tests. In one instance, performance data can be collected for each build to establish a baseline. Additionally, current performance data can be compared to previous performance data to enable performance regression to be detected.

According to another embodiment, performance testing can be initiated by way of the performance testing system 100 in connection with code check in with respect to version control component 210. In one scenario, a build can be initiated after code is checked-in to the data repository 220, and after the build is complete, performance testing can be initiated. Alternatively, the version control component 210 can initiate performance testing after code is checked in but without a build. If regression or unacceptable performance is detected, roll back to a prior version and/or build can be initiated. In another scenario, the performance testing can be initiated prior to check-in by the version control component 210. For example, executable code corresponding source code to be checked-in can be acquired with the source code or otherwise generated (e.g., invoking a compiler). Subsequently, performance tests can be run and if results are acceptable, the source code is checked-in to the data repository 220. Otherwise, if results are unaccepted, such as where performance regression detected, the version control component 210 can reject the check-in request. In other words, check-in constraints or policies can exist that govern check-in, and generally, code with unacceptable performance is not allowed to be checked in.

Regardless of implementation, performance testing can be tightly coupled with the team development system 200. As a result, performance testing can be performed automatically without depending on developers to remember to execute performance tests. Additionally, the team development system 200 can reject code that does not meet acceptable performance criteria. Further, a developer can be notified of the rejection and optionally provide at least performance data to facilitate corrective action.

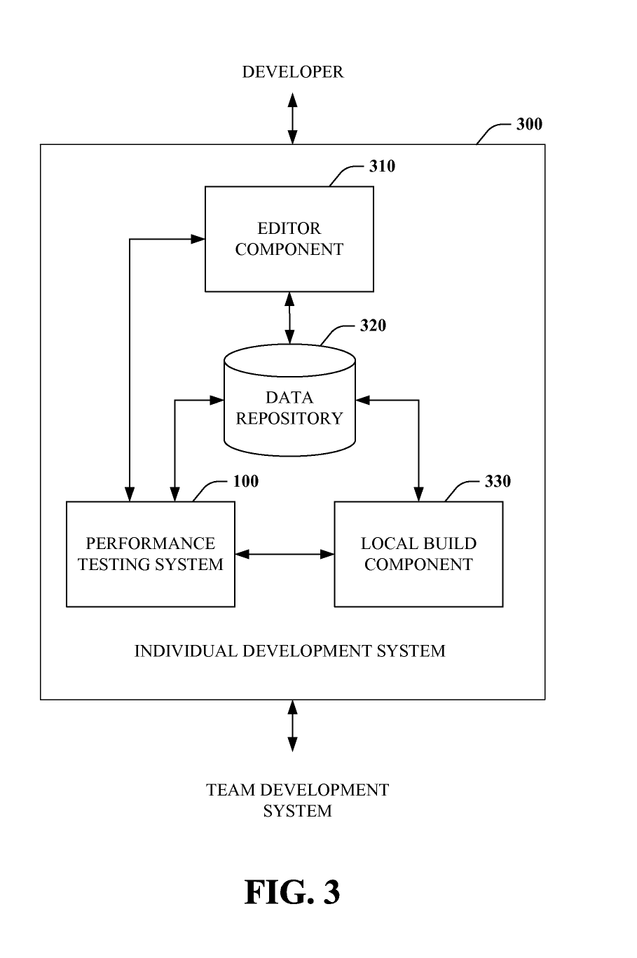

Turning attention to FIG. 3, an individual development system 300 is illustrated that also integrates the performance testing system 100. The individual development system 300 is a development environment employed by a single individual or developer. For instance, the individual development system 300 can correspond to an integrated development environment (IDE), which is a software application that provides facilities for a programmer to develop software. The individual development system 300 can receive input from a developer and output, such as source code, can be provided to the team development system 200 of FIG. 2. The individual development system 300 comprises editor component 310, data repository 320, and local build component 330, as well as performance testing system 100.

The editor component 310 is configured to enable specification and editing of source code by developers. The editor component 310 can also include other functionality associated expediting input of source code including autocomplete and syntax highlighting, among other things. Further, the editor component 310 can enable execution of a compiler, interpreter, and debugger, amongst other things associated with software development. Generated source code can be saved to the data repository 320, which is a persistent and non-volatile computer-readable storage medium. Additionally, a working copy of code checked out from the team development system 200 can also be stored locally in the data repository 320.

Further, the editor component 310 can be employed in conjunction with the performance testing system. In one instance, a developer can employ the editor to author one or more performance tests easily and at arbitrary levels of granularity employing development functionality afforded by the performance testing system 100. Performance tests can be stored locally in data repository 320 or provided to the team development system 200. Further, performance tests can be utilized in conjunction with software development with the editor component 310. In particular, performance tests can be accessible for use in developing software on a developer machine in contrast to a team development machine. For instance, the editor component 310 can include a tool window, such as a developer performance explorer, that can be configured to show performance data during development.

To aid clarity and understanding with respect to employing performance testing in combination with the editor component 310, consider the following exemplary use case. Suppose a developer starts working on a bug in a particular area in code. In a test window, the developer can filter tests to show solely performance tests and exclude others such as functional tests. From the performance tests, the developer can identify tests that are potentially affected with respect to the particular area of code associated with the bug. These tests can be promoted to a performance window and show up as a list of charts each corresponding to one of the tests. The developer can next select a measure performance button, which initiates a performance run. Each test is run a certain number of user specified number of times, and performance data is collected per test execution. The median of samples or other statistical measures is calculated and written to the data repository 320 indexed by some value, such as build identifier. The median for each test is next displayed on the corresponding chart, which provides a baseline before changes. Next, changes to code can be made, and a performance run can be initiated again. The developer can then view the charts to determine if there is regression in any of the scenarios. More changes and measures can be made until the fix is complete. The advantage here is that the performance data is measured and displayed in the developer's environment during the development process. As a result, the developer is notified of any regressions as soon as possible and does not have to make blind check in with respect to the performance impact of changes.

The local build component 330 is configured to manage production of computer executable code from source code, among other things, with respect to the individual development system 300. Like build component 230 of the team development system 200, the local build component 330 can employ compilers and linkers to compile and link files in particular order. The local build component 330 is coupled to the data repository that stores source code developed by way of the editor or acquired externally from the team development system 200, for example. After changes are made to source code, the local build component 330 can produce updated executable code. The local build component 330 can be initiated explicitly by way of a developer request or automatically upon detecting change, for example.

The local build component 330 is communicatively coupled to the performance testing system 100. Accordingly, performance testing can be initiated in conjunction with a build. For example, after a build, the local build component 330 can initiate performance testing automatically. In this manner, a performance baseline can be established. Subsequently, current performance data can be compared with previous performance data to determine if there is performance regression. A regression is detected or performance data is outside predetermined acceptable limits, the developer can be notified, wherein such notification may include a report comprising performance data and potentially additional data that may be helpful in resolving a performance issue. This is useful because developers do not need to remember to run test or determine a baseline. Rather, this happens automatically with each build and thus the developer is notified when a change is bad in terms of performance.

Performance tests are susceptible to noise, and a developer's computer can be a noisy environment. Noise can be fluctuations that obscure collection of meaningful data. One source of noise is other applications or processes running on a computer. For example, consider a situation where a performance test is executed at the same time as a system update is being processed. Here, resulting performance data will likely be skewed by the update. Further, a developer's computer can be an inconsistent environment. For instance, a test can be run while system update was being performed and the next time the test is performed a different application may be executing simultaneously. To address the noise and inconsistency, the performance testing system 100 can be configured send tests to a remote computer for execution and accept the results on the local computer. This can allow cleaner data collection and avoid noise due to use of the local computer by a developer. From a developer's perspective, the tests are running and results are returned in their development environment, but in reality, the tests are run on another machine that is less susceptible to noise and stable.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the performance testing system 100 may include such mechanisms facilitate efficient and adaptive testing.

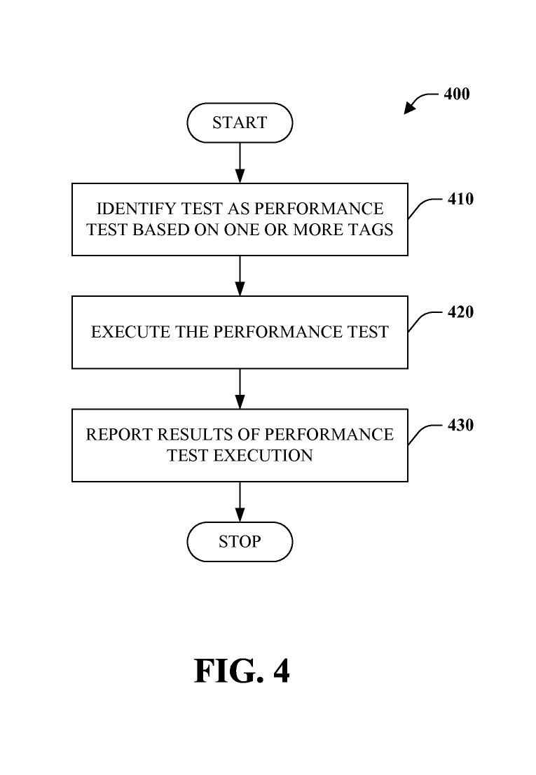

In view of the exemplary systems described above, methodologies that may be implemented in accordance with the disclosed subject matter will be better appreciated with reference to the flow charts of FIGS. 4-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 4 a performance testing method 400 is illustrated. At reference numeral 410, a performance test is identified based on one or more tags within or associated with software code, comprising computer program instructions, or a segment or portion of software code. This tag can comprise metadata that indicates that the software code is a performance test and can identify one or more data collection mechanisms for use by the test, among other things. In one instance, the tags can be implemented as a code attribute. At 420, the performance identified performance test is executed with respect to software program or portion thereof subject to test based at least in part on specified performance test metadata. Execution results in collection of performance data. At numeral 430, results of performance test execution are reported. For example, a report can be provided with charts providing a visual representation of data. Further, the report can be interactive in that data can be filtered, qualified, and aggregated, for example, in various ways based on developer input.

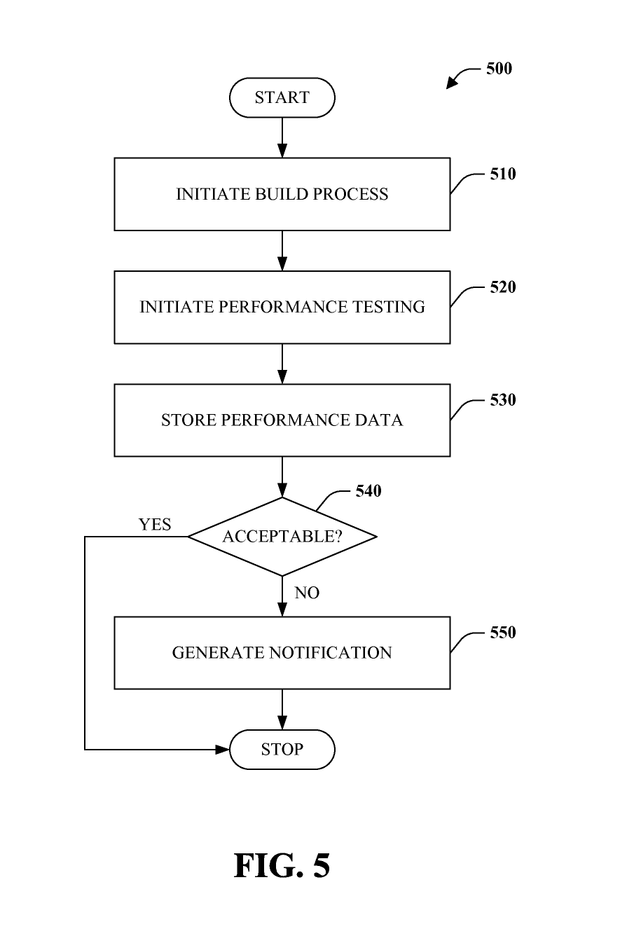

FIG. 5 shows a flow chart diagram of a build method 500. The build method 500 can be executed in the context of either a team development system or individual development system. At reference numeral 510, a build process is initiated. The build process automates generation of computer executable software from source code, among other things, by invoking one or more compilers and linkers, for example. At numeral 520, performance testing is initiated with respect to the computer executable software or a portion thereof subject to test. At reference 530, performance data collected by the test is stored. Storing the performance data allows data to be tracked over time and establishment of a baseline, among other things. A determination is made at 540 as to whether the resulting performance data is acceptable. In one instance, the determination is based on whether or not the performance data indicates regression by comparing current performance data to previous performance data produced in a prior run. In another instance, the determination is based on whether or not the performance data is outside predetermined acceptable limits. A combination of both ways of determining whether the performance data is acceptable can also be used. For example, a regression threshold of ten percent can be established. In other words, if performance regressed by less than or equal to ten percent the performance is deemed acceptable and if regression is greater than ten percent the performance is considered unacceptable. If, at 540, performance is deemed is acceptable (“YES”), the method terminates. Alternatively, if performance is unacceptable (“NO”), the method continues at numeral 550. A notification can be generated at numeral 550. For example, a developer can be notified that performance was unacceptable and optionally provided with performance data to aid resolving the performance issue.

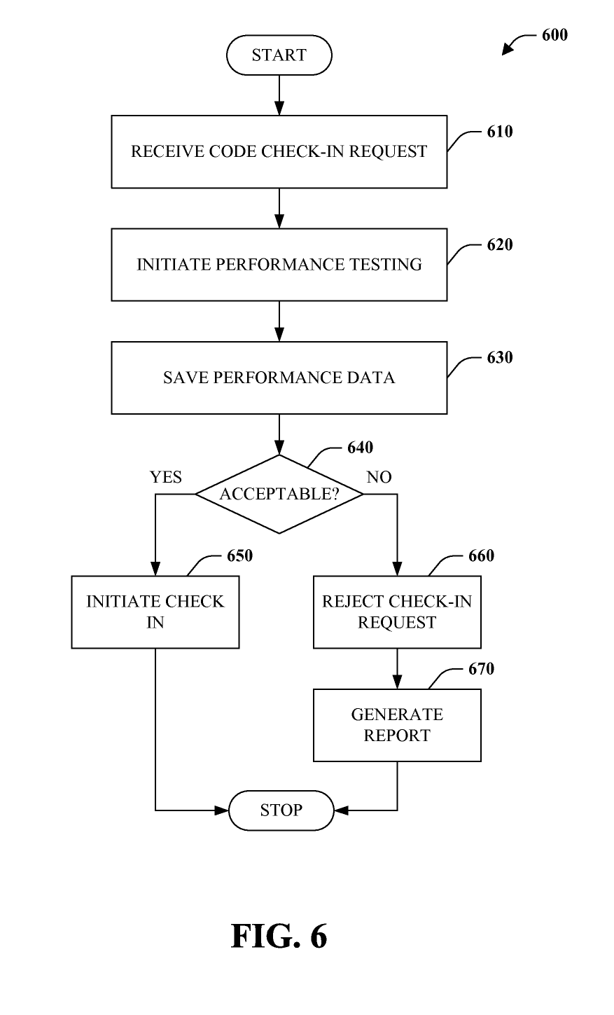

FIG. 6 depicts a flow chart diagram of a check-in method 600. At reference numeral 610, a request to check in code is received. Check-in refers to saving the program code to a shared repository, wherein version management is employed. At numeral 620, performance testing is initiated. Testing can be performed over software subject to test including the code to be checked in. Further, performance testing can be initiated over the current version without the changes if not previously done. At reference 630, performance data collected from the testing can be saved. At numeral 640, a determination is made as to whether performance is acceptable. For example, the determination can be based on whether or not performance regressed, whether performance is within or outside predetermined, acceptable limits, or a combination thereof, among other things. If performance is acceptable (“YES”), check in is initiated, or, in other words, check in is allowed to proceed and commit code to the repository. Alternatively, if performance is unacceptable (“NO”), the method continues at 660 where a check in request is rejected. Stated differently, the code is not committed to the repository. Further, at reference numeral 670, a report can be generated that comprises at least performance data, which can allow a developer, for instance to resolve the performance problem.

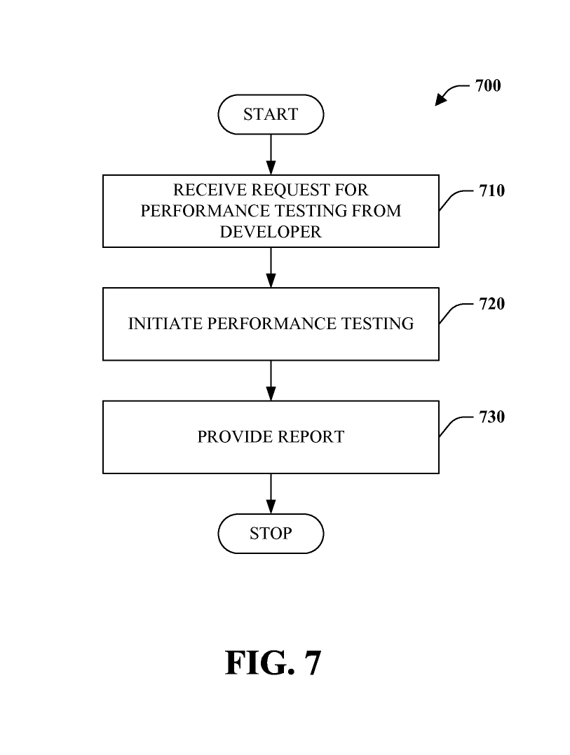

FIG. 7 illustrates a flow chart diagram of a performance testing method 700. At reference numeral 710, a request for performance testing is received from a developer on a local computer. For example, the request can be received through an integrated development environment during software development. At numeral 720, performance testing is initiated in accordance with the request. Performance data is collected and stored during test execution. At reference numeral 730, a report is generated and provided back to the developer. The report can include performance data organized in one or more of multiple different ways to facilitate analysis. Furthermore, in accordance with on aspect the report can be provided to a developer through the integrated development environment, for example by way of a developer performance window.

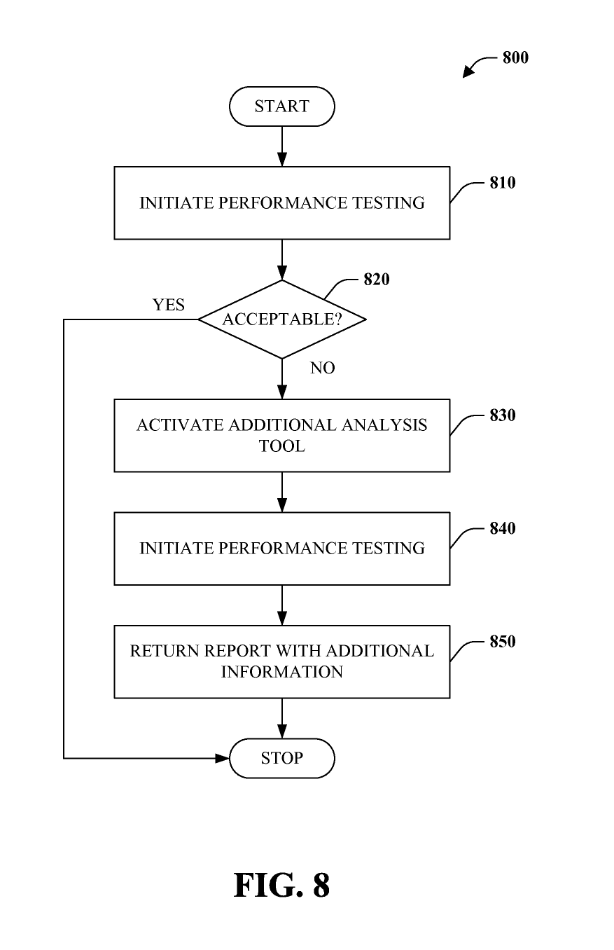

FIG. 8 is a flow chart diagram depicting a method 800 of performance testing. At reference numeral 810, performance testing is initiated. At numeral 820, a determination is made as to whether the performance is acceptable. For instance, the determination can be based on whether performance data shows regression, whether performance data is within or outside a predetermined, acceptable range, or a combination thereof. If performance is deemed acceptable (“YES”), the method terminates. If, however, performance is considered unacceptable (“NO”), the method continues at 830, where an additional analysis tool is activated. The additional tool can be profiler or tool that provides traces or other interesting information in the context of performance. At reference numeral 840, performance testing is initiated again this time with an additional analysis tool. At numeral 850, a report is generated and returned including performance data captured by one or more performance tests supplemented with additional information provided by the additional analysis tool. For example, a performance profile can be returned with results of one or more performance tests. Additional analysis tools may have been too expensive in terms of time, for example to initiate initially. However, after determining that there is a performance issue, employing additional mechanisms can be worthwhile in terms of supplying additional information aid a developer in identifying the cause of the performance issue.

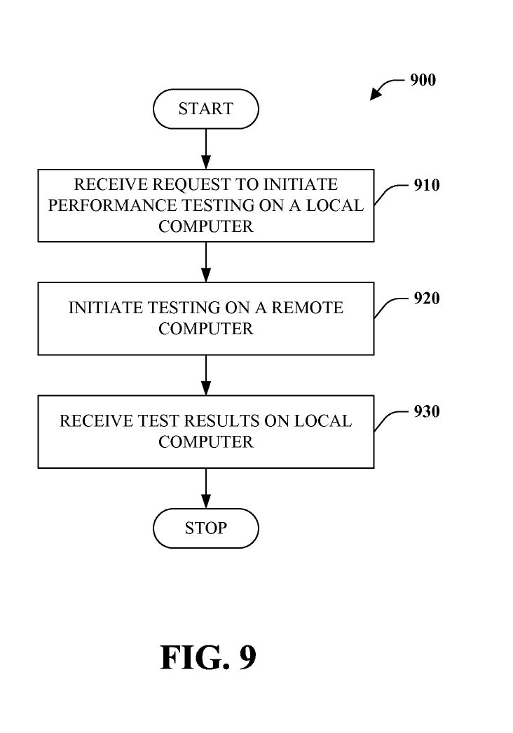

FIG. 9 is a flow chart diagram illustrating a method 900 of performance testing. At reference numeral 910, a request is received to initiate performance testing on a local computer. For example, the local computer can correspond to a developer's computer that provides a development environment with integrated performance testing. At numeral 920 testing is initiated on a remote computer. For example, tests and a test subject can be provided to a remote computer, which can execute the tests. At reference numeral 930, results of the test execution, namely performance data, can be received by the local computer to be saved and utilized to generate reports, and optionally provide notification of unacceptable performance. By moving test execution to a remote computer perhaps designed and designated for testing, noise and stability issues of a local developer computer can be avoided.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

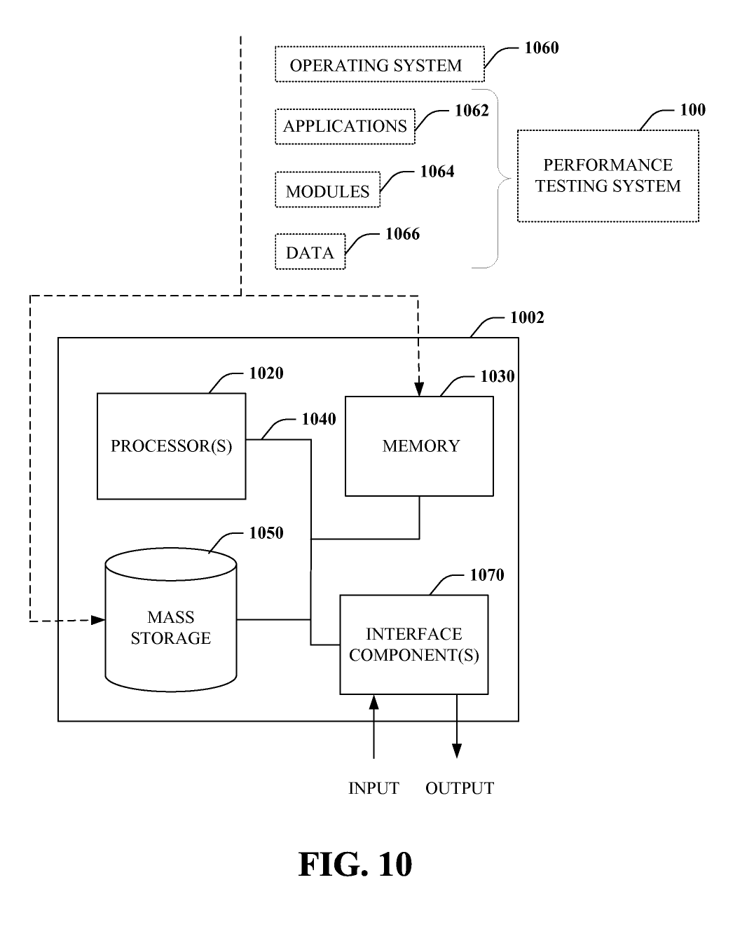

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer or computing device 1002 (e.g., desktop, laptop, tablet, server, hand-held, programmable consumer or industrial electronics, set-top box, game system, compute node . . . ). The computer 1002 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1002 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1002 can include or otherwise interact with a variety of computer-readable media to facilitate control of the computer 1002 to implement one or more aspects of the claimed subject matter. The computer-readable media can be any available media that can be accessed by the computer 1002 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 1002. Accordingly, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1002, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1002. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1002 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, performance testing system 100, or portions thereof, can be, or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the performance testing system and/or associated functionality can be embedded within hardware in a SOC architecture.

The computer 1002 also includes one or more interface components 1070 that are communicatively coupled to the system bus 1040 and facilitate interaction with the computer 1002. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1002, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., LCD, LED, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method for performance testing, comprising:
employing at least one processor configured to execute computer-executable instructions stored in memory to perform the following acts:
identifying a performance test based on a tag associated with a segment of software code; and
initiating execution of the performance test based on the tag.

2. The method of claim 1 further comprises automatically initiating execution of the performance test after executing a build process.

3. The method of claim 2 further comprises initiating the build process after code is checked-in to a repository.

4. The method of claim 1 further comprises initiating execution of the performance test automatically upon a request to check-in code to a repository.

5. The method of claim 4 further comprising rejecting the request to check-in code based on performance data collected during test execution.

6. The method of claim 1 further comprising automatically detecting performance regression based performance data collected from test execution.

7. The method of claim 1 further comprises generating a report based on performance data collected during test execution.

8. The method of claim 1 further comprises reporting results of the performance test in an integrated development environment.

9. The method of claim 1 further comprises initiating execution of the performance test on a remote computer from a local developer computer and acquiring one or more results of test on a the local developer computer.

10. The method of claim 1 further comprises activating an analysis tool and initiating execution of the performance test.

11. A performance testing system, comprising:
a processor coupled to a memory, the processor configured to execute the following computer-executable components stored in the memory:
a first component configured to support authoring of a performance test with one or more tags;
a second component configured to enable execution of the performance test and collect performance data based on the one or more tags; and
a third component configured to a report at least a subset of performance data.

12. The system of claim 11 further comprises a fourth component configured to initiate execution of the performance test automatically after a build process.

13. The system of claim 12 further comprises a fifth component configured to initiate the build process after code check-in on team development repository.

14. The system of claim 11 further comprises a fourth component configured to automatically initiate execution of the performance test prior to code check-in on team development repository.

15. The system of claim 14, the fourth component is further configured to prevent code-check-in based on one or more results of the performance test.

16. The system of claim 11 further comprising a fourth component configured to detect performance regression automatically.

17. The system of claim 11, the performance test is a unit test.

18. A computer-readable storage medium having instructions stored thereon that enable at least one processor to perform a method upon execution of the instructions, the method comprising:
executing a performance test over at least a portion of software code automatically after a build process; and
saving performance data collected during test execution.

19. The computer-readable storage medium of claim 18, the method further comprises automatically detecting performance regression based at least on the performance data collected during test execution.

20. The computer-readable storage medium of claim 18, the method further comprises executing the performance test with a data collection mechanism specified in a tag included with the performance test.
